(19) United States
(12) Patent Application Publication
(10) Pub. No.: US 2025/0275517 A1
(43) Pub. Date: Sep. 4, 2025

(54) PET PROVISIONING SYSTEM

(71) Applicant: Dorai Home, Inc., West Valley City, UT (US)

(72) Inventors: Kelsey O'Callaghan, Salt Lake City, UT (US); Jason Klug, Salt Lake City, UT (US)

(73) Assignee: Dorai Home, Inc., West Valley City, UT (US)

(21) Appl. No.: 19/069,162

(22) Filed: Mar. 3, 2025

Related U.S. Application Data
(60) Provisional application No. 63/560,691, filed on Mar. 2, 2024.

(51) Int. Cl. A01K 5/01; A01K 7/00

(52) U.S. Cl. CPC A01K 5/0135; A01K 7/00

(57) ABSTRACT

In some implementations, a pet provisioning system includes a dish, a pedestal and a mat. The dish may have a cylindrical wall, a central axis, a bottom, a top opening whose perimeter lies on an oblique plane that intersects the central axis at an angle other than normal to the central axis, and a ridge that extends below the bottom. The mat may have a top surface and a bottom surface that define a thickness. The mat may be made of diatomaceous earth and may include a mat recess extending from the top surface into the thickness. The pedestal may have a bottom end, a top end, a height, and a pedestal recess at the top end The bottom end may have a shape and size that corresponds to the mat recess. The pedestal recess may have a shape and size that corresponds to the ridge.

### CROSS-REFERENCE TO RELATED APPLICATIONS

This application claims priority to U.S. Provisional Patent Application No. 63/560,691, filed Mar. 2, 2024, titled “Pet Provisioning System” and incorporates the same herein by reference.

### TECHNICAL FIELD

Various implementations relate generally to pet provisioning systems and may include food and water dishes, mats and supports therefor.

### BACKGROUND

Pets require regular provisioning of food and water. Many pet owners provide water dishes in locations and at heights that enable their pets to regularly hydrate themselves. Pet owners may also provide separate food dishes with food for their pets-often proximate to their water dishes. In some cases, the food dishes may be provided only at specific mealtimes; in other cases (e.g., for pets that are able to regulate their own food consumption), food dishes may be available throughout the day.

Some pets may be messy when eating or drinking. Accordingly, mats may be provided with food and water dishes to contain spills and to protect floors and other surfaces near the food and water dishes. Some mats may require regular cleaning and drying to avoid the growth of mildew or to avoid attracting insects, rodents or other pests.

### SUMMARY

In some implementations, a pet provisioning system includes a dish, a pedestal and a mat.

The dish may have a cylindrical wall, a central axis, a planar bottom perpendicular to the central axis, a top opening whose perimeter lies on an oblique plane that intersects the central axis at an angle other than normal to the central axis, and a ridge that extends below the planar bottom on an opposite side of an interior space defined by the planar bottom and the cylindrical wall.

The mat may have a top surface and a bottom surface, and the top surface and the bottom surface may define a thickness. The dish may be made of a material that resists absorption of liquid. For example, the dish may be made of a ceramic. The mat may be made of diatomaceous earth. The mat may include a mat recess extending from the top surface into the thickness. In some implementations, the top surface of the mat may be shaped as a closed composite figure that is void of sharp angles. In other implementation, the mat may be generally rectangular in shape, with rounded corners and a chamfered edge along a perimeter of its top surface.

The pedestal may have a bottom end, a top end, a height, and a pedestal recess at the top end. The bottom end may have a shape and size that corresponds to the mat recess-such that the bottom end can be disposed into the mat recess; and when the bottom end is disposed in the mat recess, the mat recess and bottom end cooperate to substantially resist translation of the pedestal relative to the mat. The pedestal recess may have a shape and size that corresponds to the ridge such that the ridge can be disposed into the pedestal recess; and when the ridge is disposed in the pedestal recess, the pedestal recess and the ridge cooperate to substantially resist translation of the dish relative to the pedestal. The pedestal may be made of a silicone having a Shore A durometer of about 50.

### BRIEF DESCRIPTION OF THE DRAWINGS

FIG. 1 is a perspective view of an exemplary pet provisioning system having a mat, a pedestal and a dish

FIGS. 2A and 2B illustrate details of an exemplary dish.

FIG. 3 is an exploded view of the exemplary system shown in FIG. 1.

FIG. 4 illustrates details of an exemplary pedestal.

FIG. 5 is a left-side view of an exemplary system;

FIG. 6 is a right-side view thereof;

FIG. 7 is a front view thereof;

FIG. 8 is a back view thereof;

FIG. 9 is a top view thereof; and

FIG. 10 is a bottom view thereof.

### DETAILED DESCRIPTION

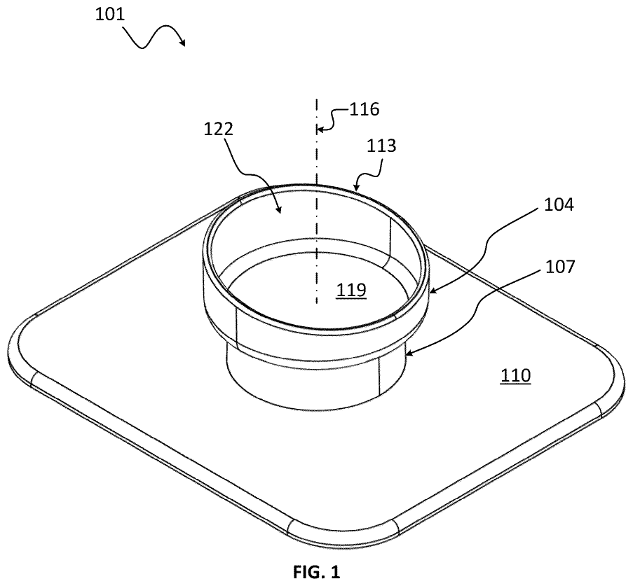

FIG. 1 illustrates an exemplary pet provisioning system 101. The exemplary system 101 may be employed as a food or water dish for small pets, such as, for example, dogs or cats. As shown, the system 101 may include a dish 104, a pedestal 107 and a mat 110.

In some implementations, the dish 104 has a generally cylindrical shape defined by a cylindrical wall 113 and characterized by a central axis 116. In some implementations, the dish 104 has a planar bottom 119 (e.g., a bottom 119 that is perpendicular to the central axis 116). In other implementations, the dish 104 may have a bottom 119 with a different shape (e.g., a bowl shape, or some other non-planar shape). The cylindrical wall 113 and bottom 119 define an interior space 122 that may be configured to hold food or water for a pet.

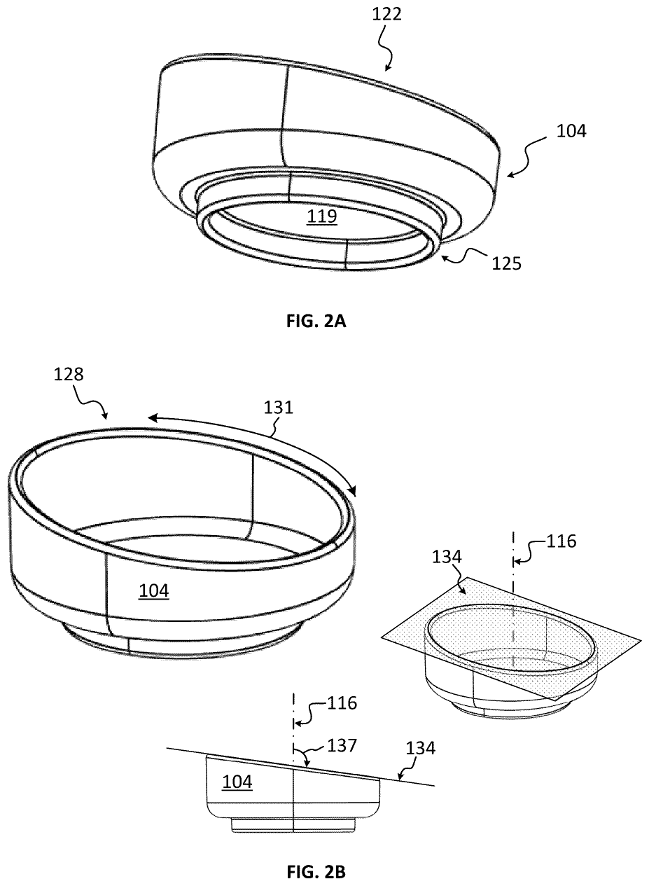

With reference to FIG. 2A, on an opposite of the bottom 119, relative to the interior space 122, the dish 104 may include a ridge 125. Turning to FIG. 2B, the dish 104 includes a top opening 128. In some implementations, a perimeter 131 of the top opening 128 may lie on an oblique plane 134 that intersects the central axis 116 at an angle 137 other than normal to (i.e., perpendicular to) the central axis 116.

In some implementations, the dish 104 comprises a material that resists absorption of liquid (e.g., water, pet drool, moisture inherent in pet food). For example, the dish 104 may be made of a ceramic, or of another material with a waterproof interior coating.

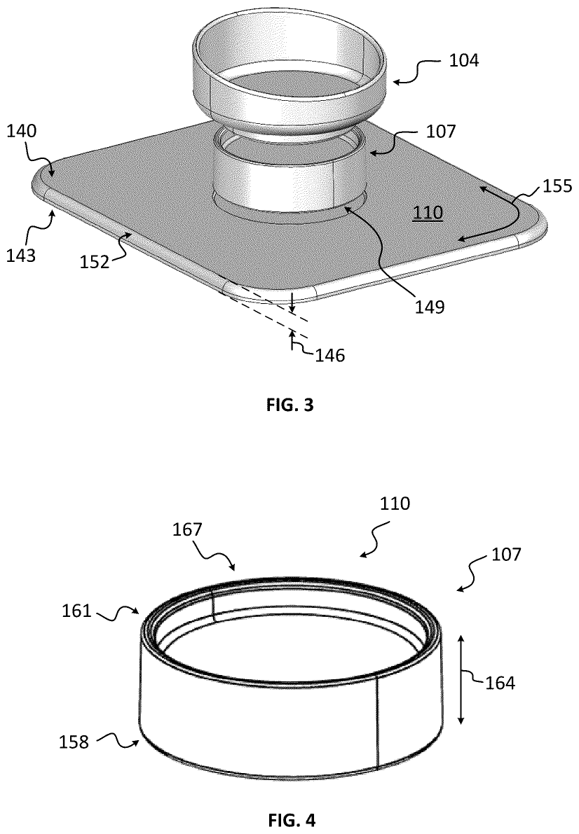

As shown in FIG. 3, the system 101 further includes a mat 110 having a top surface 140 and a bottom surface 143 that define a thickness 146. As shown, the mat 110 includes a mat recess 149 that extends from the top surface 140 into the thickness 146. In some implementations, the mat 110 comprises diatomaceous earth, which naturally absorbs water and other liquid, wicking it into the mat 110 and facilitating its evaporation from a larger surface area of the mat than that area through which the water or liquid was initially absorbed. In such implementations, mildew growth may be inhibited (by both the natural absorption and subsequent rapid evaporation of water and liquid and the inherent natural properties of diatomaceous earth); moreover, attraction of insects, rodents and other pests may be minimized, along with unpleasant odors that may otherwise be associated with persistent moisture.

The mat 110 may be configured to omit sharp edges or corners—or at least sharp edges or corners with which a pet may contact. For example, the top surface 140 may be shaped as a closed composite figure (e.g., a figure having only straight and curved lines) that is void of sharp angles. As another example, the shape may be generally rectangular, with rounded corners. An edge 152 along a perimeter 155 of the top surface 140 may be chamfered.

The system 101 may further include a pedestal 107 having a bottom end 158, a top end 161 and a height 164, as shown in FIG. 4. The bottom end 158 may have a shape and size that corresponds to the mat recess 149—such that the bottom end 158 can be disposed in the mat recess 149; and when the bottom end 158 is so disposed in the mat recess 149, the mat recess 149 and bottom end 158 cooperate to substantially resist translation of the pedestal 107 relative to the mat 110.

As shown, the pedestal 107 further includes a pedestal recess 167 at the top end 161. The pedestal recess 167 may have a shape and size that corresponds to the ridge 125—such that the ridge 125 can be disposed into the pedestal recess 167; and when the ridge 125 is disposed into the pedestal recess 167, the pedestal recess 167 and the ridge 125 cooperate to substantially resist translation of the dish 104 relative to the pedestal 107.

As used herein, “substantially resist” may mean resisting translation of more than a small percentage (e.g., 1%, 5%, 10%, 25%) of the dimensions of the mat recess 149 or pedestal recess 167 (e.g., a diameter, in the case of a circular recess) or bottom end 158 or ridge 125 (e.g., the diameter, in the case of a circular bottom end 158 or circular ridge 125). “Resisting” may mean resisting relative to a force that is commensurate with a pet drinking water or eating from the dish. “Cooperate” may mean that the mat recess 149 (or pedestal recess 167) is not only deep enough to resist translation of the bottom end 158 of the pedestal 107 (or ridge 125) when subjected to forces of a pet drinking or eating from the dish, but also that the proportions of the height 164 and a lateral dimension of the pedestal 107 are such that a low center-of-gravity is maintained—to further prevent the dish and/or pedestal from being tipped over when a pet cats or drinks from the dish.

In some implementations, the pedestal 107 comprises a polymer with some flexibility and resilience to cushion contact between the pedestal 107 and the dish 104 or between the pedestal 107 and the mat 110. For example, in some implementations, the polymer has a Shore A durometer value of about 50. As used herein, “about,” “approximately” or “substantially” may mean within 1%, or 5%, or 10%, or 20%, or 50%, or 100% of a nominal value. In some implementations, the polymer is silicone.

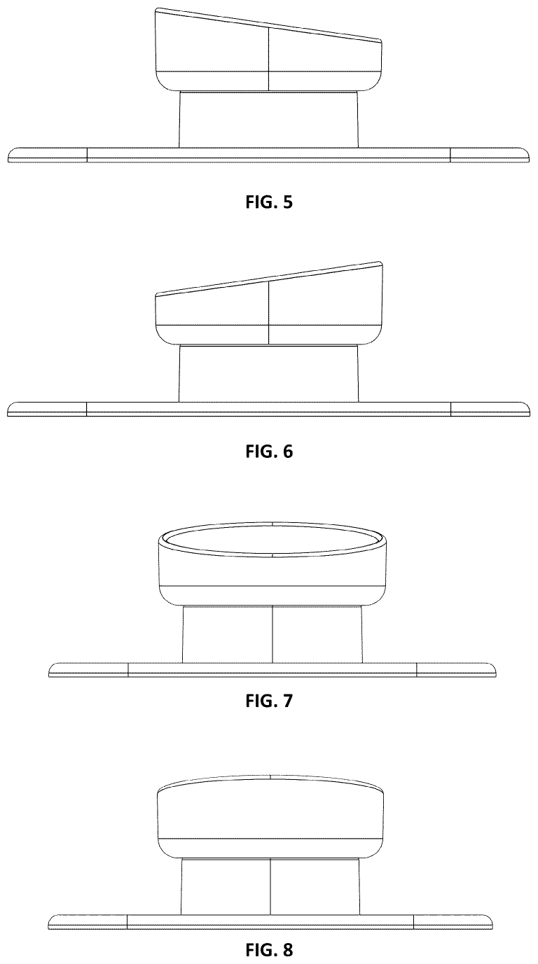

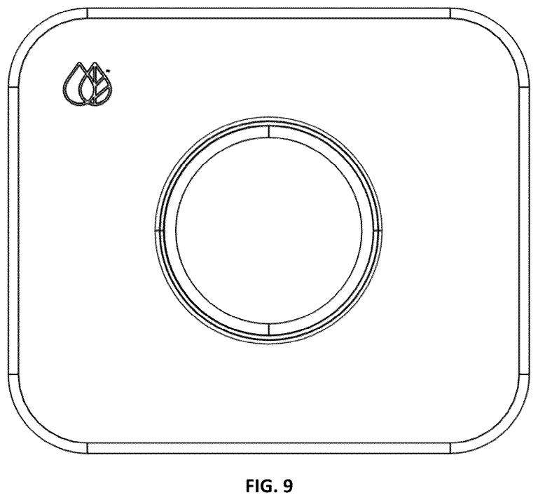

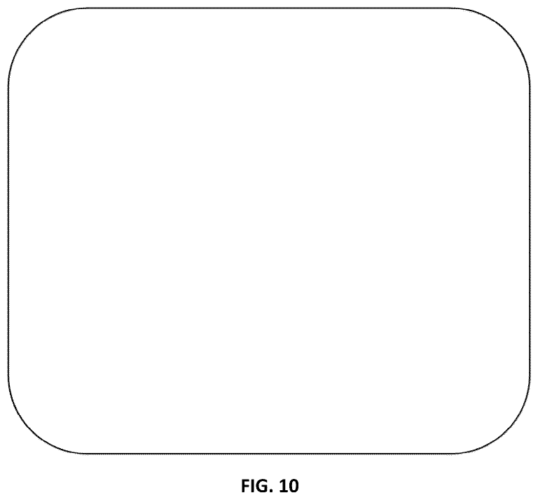

FIGS. 5-10 illustrate additional views of an exemplary implementation of a pet provisioning system. In particular, FIG. 5 illustrates a left view of one implementation; FIG. 6 illustrates a right view thereof; FIG. 7 illustrates a front view thereof; FIG. 8 illustrates a back view thereof; FIG. 9 illustrates a top view thereof; and FIG. 10 illustrates a bottom view thereof.

Several implementations have been described with reference to exemplary aspects, but it will be understood by those skilled in the art that various changes may be made and equivalents may be substituted for elements thereof without departing from the contemplated scope. For example, recesses and the corresponding ridge or bottom edge may have difference shapes or sizes, or different means of cooperating to limit translation. Dishes may have shapes other than cylinders. The top edge may have a different shape or be at a different angle relative to a central axis. Different materials may be employed, including polymers, rubbers, plastics, synthetic and real woods, ceramics, etc. Components of the system may be secured to each other (e.g., with adhesives, fasteners, integrated cooperating threads or other twist-lock mechanisms, magnets, etc.). Mats may take various shapes, including irregular compound shapes or polygons. Some systems may include two dishes (e.g., one for water, one for food), two pedestals and two recesses in the mat. Some systems may omit the pedestal for one or more dishes, such that a dish may be partially disposed directly in the mat.

Many other variations are possible, and modifications may be made to adapt a particular situation or material to the teachings provided herein without departing from the essential scope thereof. Therefore, it is intended that the scope include all aspects falling within the scope of the appended claims.

What is claimed is:

1. A pet provisioning system, comprising:
a dish having a cylindrical wall, a central axis, a planar bottom perpendicular to the central axis, a top opening whose perimeter lies on an oblique plane that intersects the central axis at an angle other than normal to the central axis, and a ridge that extends below the planar bottom on an opposite side of an interior space defined by the planar bottom and the cylindrical wall;
a mat having a top surface and a bottom surface, wherein the top surface and the bottom surface define a thickness, the mat comprising diatomaceous earth and further including a mat recess extending from the top surface into the thickness;
a pedestal having a bottom end, a top end, a height, and a pedestal recess at the top end;
wherein the bottom end has a shape and size that corresponds to the mat recess-such that the bottom end can be disposed into the mat recess; and when the bottom end is disposed in the mat recess, the mat recess and bottom end cooperate to substantially resist translation of the pedestal relative to the mat; and
wherein the pedestal recess has a shape and size that corresponds to the ridge-such that the ridge can be disposed into the pedestal recess; and when the ridge is disposed in the pedestal recess, the pedestal recess and the ridge cooperate to substantially resist translation of the dish relative to the pedestal.

2. The pet provisioning system of claim 1, wherein the dish comprises a material that resists absorption of liquid.

3. The pet provisioning system of claim 2, wherein the material comprises ceramic.

4. The pet provisioning system of claim 1, wherein the pedestal comprises silicone having a Shore A durometer of about 50.

5. The pet provisioning system of claim 1, wherein the top surface of the mat is shaped as a closed composite figure that is void of sharp angles.

6. The pet provisioning system of claim 1, wherein the mat is generally rectangular in shape, with rounded corners and a chamfered edge along a perimeter of its top surface.
